(19) United States
(12) Patent Application Publication
(10) Pub. No.: US 2015/0369909 A1
(43) Pub. Date: Dec. 24, 2015

(54) IMAGE SENSOR FOR LARGE AREA ULTRASOUND MAPPING

(71) Applicant: Imperium, Inc., Beltsville, MD (US)

(72) Inventors: Robert S. LASSER, Washington, DC (US); David C. RICH, Stafford, VA (US)

(21) Appl. No.: 14/308,979

(22) Filed: Jun. 19, 2014

(51) Int. Cl. G01S 7/52; G01S 15/02

(52) U.S. Cl. CPC G01S 7/52017; G01S 15/02

(57) ABSTRACT

An image sensor includes a source configured to output ultrasound, a probe for emitting the ultrasound onto a scan area, the probe being moveable relative to at least two scan locations of the scan area such that the ultrasound will be focused on each of the at least two scan locations as the probe is moved relative to the scan area to provide an array of scanned images, an ultrasonic, two-dimensional array receiver configured to receive ultrasound reflected from each of the at least two scan locations, and a processing unit configured to generate, for a first of the scan locations, a two-dimensional image of the first scan location based on an intensity of the reflected ultrasound from the first scan location, and to generate an aggregate two-dimensional image for the first scan location which integrates plural two-dimensional images generated using reflected ultrasound of the at least two scan locations.

### FIELD

The present disclosure relates to an ultrasonic image sensor configured to generate an aggregate two-dimensional image from a plurality of scan locations, and to a method of operating a probe to generate an aggregate two-dimensional image from a plurality of scan locations.

### BACKGROUND

Ultrasonic image sensors have been used in various material testing or measurement applications. For example, ultrasonic imaging has been used in non-destructive testing applications such as the testing of the properties of manufactured materials (e.g., testing for corrosion in aircraft wings). Ultrasonic imaging has further been used in medical imaging applications such as human soft tissue diagnosis.

Known ultrasonic image sensors used to perform inspection or testing are, however, limited to providing static images for each separate scanning operation, which is limited in area to the capabilities of the sensor used to perform the scanning operation. In the area of non-destructive inspection (NDI), it is common for the sensor or probe to be smaller than the area under inspection (e.g., an area of damage). For example, in the case of corrosion or welds in pipelines or damage to an airplane fuselage, the damage can encompass several square inches, while the sensor used in the inspection has an inspection area that is an inch or two in size.

### SUMMARY

An exemplary embodiment of the present disclosure provides an ultrasonic image sensor which includes an ultrasonic source configured to output ultrasound, and a probe for emitting the ultrasound onto a scan area. The probe is moveable relative to at least two adjacent scan locations of the scan area such that the ultrasound will be focused on each of the at least two scan locations as the probe is moved relative to the scan area to provide an array of scanned images. The exemplary ultrasonic image sensor also includes an ultrasonic, two-dimensional array receiver configured to receive ultrasound reflected from each of the at least two scan locations. In addition, the exemplary ultrasonic image sensor includes a processing unit configured to generate, for a first of the two scan locations, a two-dimensional image of the first scan location based on an intensity of the reflected ultrasound from the first scan location, and to generate an aggregate two-dimensional image for the first scan location which integrates plural two-dimensional images generated using reflected ultrasound of the at least two scan locations based on a position of the probe relative to the at least two scan locations, respectively.

An exemplary embodiment of the present disclosure provides a method of operating an ultrasonic image sensor, in accordance with the exemplary embodiments described above. The exemplary method includes outputting ultrasound from a probe onto a scan area, moving the probe relative to at least two adjacent scan locations of the scan area such that the ultrasound will be focused on each of the at least two scan locations as the probe is moved relative to the scan area to provide an array of scanned images, and receiving ultrasound reflected from each of the at least two scan locations. In addition, the exemplary method includes generating, for a first of the two scan locations, a two-dimensional image of the first scan location based on an intensity of the reflected ultrasound from the first scan location, and generating an aggregate two-dimensional image for the first scan location which integrates plural two-dimensional images generated using reflected ultrasound of the at least two scan locations based on a position of the probe relative to the at least two scan locations, respectively.

An exemplary embodiment of the present disclosure also provides a non-transitory computer-readable medium that has tangibly recorded thereon a computer program that, when executed, causes a processor of an ultrasonic image sensor to perform operations including: (i) outputting ultrasound from a probe onto each scan location of a scan area over which the image sensor is moved, such that the ultrasound will be focused on each of the at least two scan locations as the image sensor is moved relative to the scan area to provide an array of scanned images; (ii) receiving ultrasound reflected from each of the at least two scan locations; (iii) generating, for a first of the two scan locations, a two-dimensional image of the first scan location based on an intensity of the reflected ultrasound from the first scan location; and (iv) generating an aggregate two-dimensional image for the first scan location which integrates plural two-dimensional images generated using reflected ultrasound of the at least two scan locations based on a position of the probe relative to the at least two scan locations, respectively.

An exemplary embodiment of the present disclosure provides an ultrasonic image sensor which includes an ultrasonic source configured to output ultrasound, and a probe for emitting the ultrasound onto a scan area. The probe is moveable relative to at least two adjacent scan locations of the scan area such that the ultrasound will be focused on each of the at least two scan locations as the probe is moved relative to the scan area to provide an array of scanned images. In addition, the ultrasonic image sensor includes an ultrasonic, two-dimensional array receiver configured to receive ultrasound transmitted through each of the at least two scan locations. The exemplary ultrasonic image sensor also includes a processing unit configured to generate, for a first of the two scan locations, a two-dimensional image of the first scan location based on an intensity of the ultrasound transmitted through the first scan location, and to generate an aggregate two-dimensional image for the first scan location which integrates plural two-dimensional images generated using ultrasound transmitted through the at least two scan locations based on a position of the probe relative to the at least two scan locations, respectively.

### BRIEF DESCRIPTION OF THE DRAWINGS

Additional refinements, advantages and features of the present disclosure are described in more detail below with reference to exemplary embodiments illustrated in the drawings, in which:

FIG. 1 is a block diagram of an ultrasonic image sensor according to an exemplary embodiment of the present disclosure;

FIG. 2 is a block diagram of an ultrasonic image sensor according to an exemplary embodiment of the present disclosure;

FIG. 3 is a block diagram of a processing unit included in the ultrasonic image sensor shown in FIG. 1;

FIG. 4 is an explanatory diagram illustrating an operation of scanning multiple scan locations with the ultrasonic sensor of the present disclosure;

FIG. 5 is a block diagram of an ultrasonic image sensor according to an exemplary embodiment of the present disclosure;

FIG. 6 illustrates an example of a plurality of two-dimensional images which are generated for one or more scan locations as the probe of the image sensor of FIG. 1 is moved relative to the one or more scan locations;

FIG. 7 illustrates an example of a scan area which is a curved surface;

FIG. 8 illustrates an example of a scan area which is a flat surface;

FIG. 9 is an example of distorted imaging used for refining a flat surface pixel selection algorithm according to an exemplary embodiment of the present disclosure;

FIG. 10 illustrates an example of an aggregate, two-dimensional image which can be generated by the image sensor of the present disclosure;

FIG. 11 illustrates an example of an overlap region between the two-dimensional images generated for different scanning operations;

FIG. 12 illustrates an example of graphical effects the processing unit of the image sensor can apply to different features in an aggregate, two dimensional image for a scan area;

FIG. 13 illustrates an example of graphical effects the processing unit of the image sensor can apply to different features in an aggregate, two dimensional image for a scan area;

FIG. 14 illustrates an example of graphical effects the processing unit of the image sensor can apply to different features in an aggregate, two dimensional image for a scan area;

FIG. 15 illustrates an example of a freehand scanning system onto which the probe of the image sensor of the present disclosure can be mounted; and

FIG. 16 illustrates a block diagram of an ultrasonic image sensor according to an exemplary embodiment of the present disclosure.

In principle, identical or similarly functioning parts are provided with the same reference symbols in the drawings.

### DETAILED DESCRIPTION

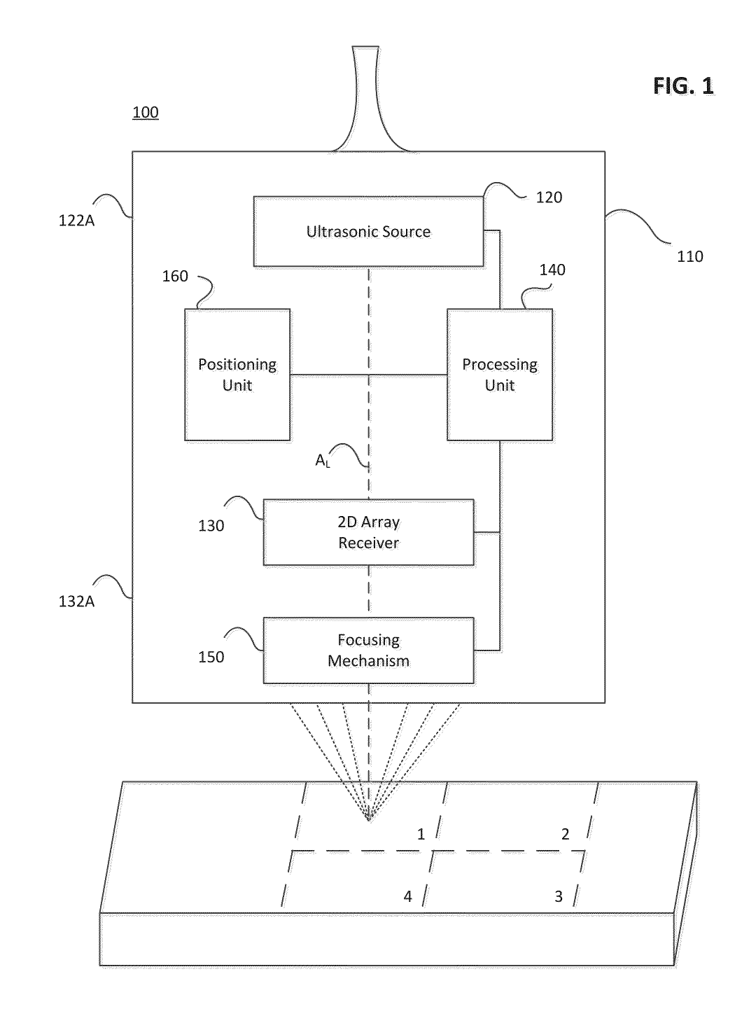

FIG. 1 illustrates a block diagram of an ultrasonic image sensor 100 according to an exemplary embodiment of the present disclosure. The image sensor 100 includes a probe 110 that is moveable relative to a plurality of scan locations of a scan area, such as part of an aircraft wing, for example. In the example of FIG. 1, four scan locations 1-4 are shown. The scan locations in FIG. 1 are each approximately one square inch in size. The size and number of the scan locations in the scan area is dependent on the scanning capabilities of the image sensor, and the present disclosure is not limited to the example shown in FIG. 1.

The image sensor 100 also includes an ultrasonic source 120 that is configured to output ultrasound 122 as acoustic energy. In accordance with an exemplary embodiment, the ultrasonic source 120 may be a source transducer for generating the ultrasound. The ultrasonic source 120 may be formed from a piezoelectric material. The piezoelectric material may be composed of ceramic or polymer, or composites thereof. Any suitable piezoelectric ceramic- or polymer-containing material can be utilized. The material should be capable of generating a pulse of acoustic energy in response to an electrical stimulus. As such, the ultrasonic source 120 is in electrical communication with a device which provides an electrical pulse thereto (not shown). Optionally, the piezoelectric polymer-containing material is flexible and thus conformable to the surface of an object being imaged. According to an exemplary embodiment, the piezoelectric polymer-based containing material includes polyvinylidene difluoride (PVDF). According to another exemplary embodiment, the piezoelectric polymer-containing material includes a copolymer of polyvinylidene difluoride, such as a polyvinylidene difluoride-trifluoroethylene (PVDF-TrFE). According to an exemplary embodiment, the piezoelectric ceramic-containing material includes lead zirconate titanate (PZT).

The ultrasonic source 120 of the present disclosure is capable of emitting broadband acoustic energy. For example, the ultrasonic source 120 is capable of emitting acoustic energy with a frequency band of 0.1-20 MHz. Through material selection and/or physical design, one or more transducers can be provided capable of emitting the above-mentioned band.

According to the illustrated embodiment, the ultrasonic source 120 is positioned proximate to a first longitudinal end 122A of the probe 110, and emits ultrasound along an imaging path A_{L} which corresponds to a longitudinal axis of the probe 110.

In the example of FIG. 1, the probe 110 is moveable relative to the four scan locations 1-4 of the scan area. The probe 110 is therefore configured to emit ultrasound onto each scan location as the probe 110 is moved relative to each scan location. For instance, as the probe 110 is moved over scan location 1, the probe 110 emits ultrasound onto scan location 1, as shown in FIG. 1. As the probe 110 is moved to scan location 2, the probe 110 then emits ultrasound onto scan location 2, and so on. Thus, the probe 110 is moveable relative to the scan locations of the scan area such that the ultrasound will be separately focused on the respective scan locations as the probe 110 is moved relative to the scan locations in the scan area to provide an array of scanned images.

The image sensor 100 also includes an ultrasonic, two-dimensional array receiver 130 and a processing unit 140. The two-dimensional array receiver 130 is configured to receive ultrasound reflected from each scan location over which the probe 110 is moved. As shown in the exemplary embodiment of FIG. 1, the two-dimensional array receiver 130 is positioned proximate to a second longitudinal end 132A of the probe 110, which is opposite the first longitudinal end 122A of the probe 110.

The two-dimensional array receiver 130 includes piezoelectric material that is configured to convert ultrasound acoustic energy which is incident thereon to electrical signals which can then be utilized to generate an appropriate output, such as an image. That is, ultrasound acoustic energy reflected from one of the scan locations and incident on the piezoelectric material is converted into electrical signals that can be processed by the processing unit 140. The two-dimensional array receiver 130 may include the processing circuitry and image processing techniques, including data acquisition, digital signal processing, and video/graphics hardware and/or software, as disclosed in U.S. Pat. No. 5,483,963, the disclosure of which is incorporated by reference herein in its entirety. According to an exemplary embodiment, the two-dimensional array receiver 130 can include any number of piezoelectric arrays that are known in the art. An array of PZT detectors, as described in the above-mentioned U.S. Pat. No. 5,483,963, can be used to form an imaging array. As additional examples, arrays of piezoelectric polyvinylidene difluoride (PVDF) polymers described in U.S. Pat. No. 5,406,163 or U.S. Pat. No. 5,283,438, the disclosures of which are hereby incorporated by reference in their entirety, can also be used.

In accordance with an exemplary embodiment, the two-dimensional array receiver 130 includes a plurality of sensors arranged in n rows and n columns, where n is greater than or equal to two. For example, the two-dimensional array receiver 130 may include a plurality of sensors arranged in 120 rows by 120 columns, such that 14,400 independent ultrasound receivers convert received ultrasound to pixel voltages.

In accordance with an exemplary embodiment, the ultrasonic source 120 may also be a two-dimensional array source configured to output the ultrasound two-dimensionally.

In the illustrated example of FIG. 1, the image sensor 100 may also include a focusing mechanism 150 configured to focus the ultrasound output from the ultrasonic source onto one of the scan locations on which the probe is moved. In addition, the focusing mechanism 150 may also be configured to focus the ultrasound respectively reflected from each of the scan locations relative to which the probe is moved onto the two-dimensional array receiver 130. In accordance with an exemplary embodiment, the focusing mechanism 150 may include one or more lenses configured to perform these functions.

In accordance with an exemplary embodiment, the ultrasonic source 120 and two-dimensional array receiver 130 may be combined into a single transceiver, as disclosed in U.S. Pat. No. 8,662,395, the entire disclosure of which is hereby incorporated by reference. In this configuration, the focusing mechanism 150 may include an electronic beamformer as disclosed in U.S. Pat. No. 8,662,395 for focusing the ultrasound output from the transceiver onto one of the scan locations on which the probe is moved, and/or focus the ultrasound respectively reflected from each of the scan locations relative to which the probe is moved onto the transceiver.

As illustrated in FIG. 1, the image sensor 100 also includes a positioning unit 160 which is configured to determine the position of the probe 110 relative to the scan locations in the scan area over which the probe 110 is moved. The positioning unit 160 is configured to determine the positioning of the probe 110 so that pixels in two-dimensional images generated by the processing unit 140, as described hereinafter, are respectively assigned a positional value. In the example of FIG. 1, the positioning unit 160 is illustrated as being within the probe 110. The present disclosure is not limited thereto. The positioning unit 160 can be external to the probe 110, and be electrically connected to the processing unit 140 to transmit positional information to the processing unit 140. In accordance with an exemplary embodiment, the positioning unit 160 may be implemented as a wheeled encoder. Additional examples of the positioning unit 160 are described herein.

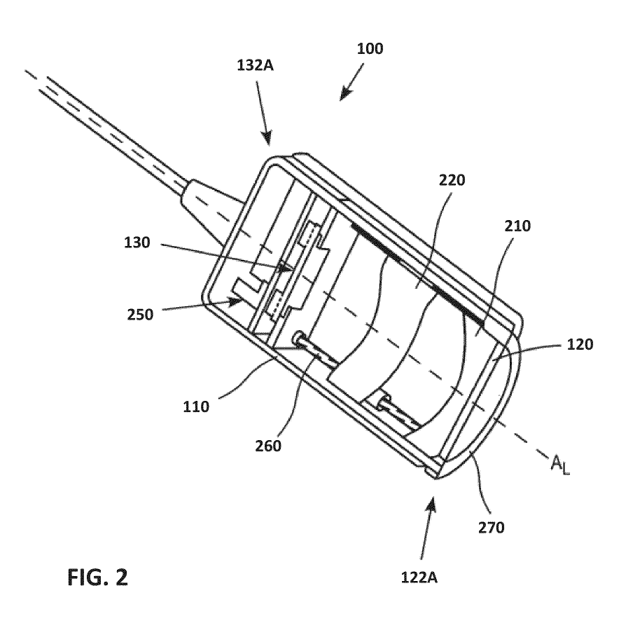

FIG. 2 is a block diagram illustrating an exemplary configuration of the image sensor 100 according to the present disclosure utilizing one or more lenses in the focusing mechanism 150 for focusing the ultrasonic energy. For example, the probe 110 can include one or more lenses configured to focus the ultrasound output from the ultrasonic source 110 onto one of the scan locations on which the probe 110 is moved. As illustrated in FIG. 2, the image sensor 100 generally includes, or is centered on, a longitudinal axis A_{L} which according to the illustrated embodiment also defines an imaging path.

In the exemplary embodiment of FIG. 2, the ultrasonic source 120 is configured to generate ultrasound as acoustic energy as in FIG. 1. The ultrasonic source 120 is formed from a piezoelectric material, which, as described above, can be a ceramic or polymer material, or composites thereof. The ultrasonic source 120 is in electrical communication with a device which provides an electrical pulse thereto (not shown). As described above with respect to FIG. 1, the ultrasonic source 120 illustrated in FIG. 2 is capable of emitting broadband acoustic energy. According to the illustrated embodiment of FIG. 2, the ultrasonic source 120 is positioned proximate to a first longitudinal end 122A of the image sensor 100.

The image sensor 100 may also include a first acoustic lens 210, as well as an optional second acoustic lens 220. The first acoustic lens 210 and the second acoustic lens 230, if present, are movably mounted on guides or rails 260 such that their position can be changed along the longitudinal direction. A suitable mechanism, such as a motor 250 can be provided to adjust the longitudinal position of the first acoustic lens 210 and the second acoustic lens 220. According to the present disclosure, additional lenses may be included in the image sensor 100.

As illustrated in FIG. 2, the ultrasonic source 120 can be mounted to a surface 270 of the first acoustic lens 210 which is proximate to the first longitudinal end 122A of the image sensor 100.

The first acoustic lens 210 and the second acoustic lens 220, if present, act to focus acoustic energy onto the two-dimensional array receiver 130. As described above with respect to FIG. 1, the two-dimensional array receiver 130 is configured to convert acoustic energy which is incident thereon to electrical signals which can then be utilized to generate an appropriate output, such as an image.

Since both the ultrasonic source 120 and the two-dimensional array receiver 130 of the image sensor 100 of FIGS. 1 and 2 commonly rely on piezoelectric properties, it is possible to combine the functionality of both the ultrasonic source 120 and the two-dimensional array receiver 130 into a single component. Thus, for example, with the proper supporting connections and electronics, the thin sheet of piezoelectric polymer-containing material of the ultrasonic source 120 illustrated in FIGS. 1 and 2 can function as both a source of ultrasonic energy, as well as the two-dimensional array receiver 130, as a single transceiver, as described above. When operating as a source, electrical impulses are utilized to produce a mechanical response thereby generating a pulse of ultrasonic energy. When operating as a sensor, forces incident thereon results in the generation of electrical signals which can be processed and interpreted. The ability to combine source and sensor functionality in a single transceiver component provides advantages in terms of simplification, miniaturization, and cost savings. Thus, for example, the piezoelectric material of the transceiver can function as a source, as well as a sensor providing feedback that can be used for output during operation in A-scan mode. It is also contemplated that a device of the present disclosure be operable in both A-scan and C-scan modes simultaneously. Thus, for example, the piezoelectric material can function as a source and receiver providing A-scan output, and the two-dimensional array receiver providing signals used to produce C-scan output.

In above-described configuration where the ultrasonic source 120 and the two-dimensional array receiver 130 are combined into a single transceiver, the focusing mechanism 150 may include an electronic beamformer, as described above. The electronic beamformer may be configured to focus the ultrasound output from the transceiver onto one of the scan locations on which the probe is moved, and/or focus the ultrasound respectively reflected from each of the scan locations relative to which the probe is moved onto the transceiver.

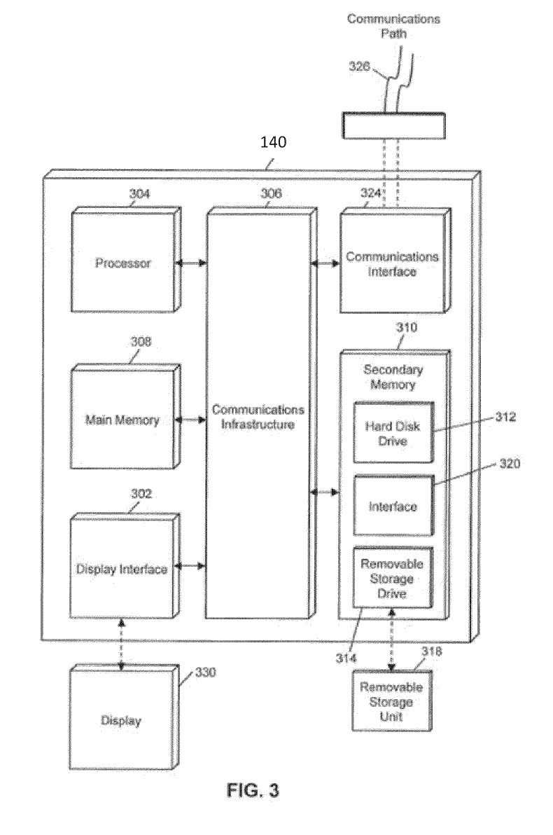

FIG. 3 illustrates an exemplary embodiment of the processing unit 140 of the present disclosure. FIG. 3 illustrates a processing unit 140 in which embodiments of the present disclosure, or portions thereof, can be implemented as computer-readable code. For example, the processing unit 140 can be implemented using hardware, software, firmware, non-transitory computer readable media having instructions tangibly recorded thereon, or a combination thereof and may be implemented in one or more computer systems or other processing systems. Hardware, software, or any combination thereof may embody modules and components used to implement the exemplary embodiments of the image sensor of FIGS. 1 and 2.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 318, and a hard disk installed in hard disk drive 312.

Various embodiments of the present disclosure are described in terms of the functions of the processing unit 140. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor 304 may be a special purpose or a general purpose processor device. The processor device 304 may be connected to a communication infrastructure 306, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The processing unit 140 may also include a main memory 308 (e.g., random access memory, read-only memory, etc.), and may also include a secondary memory 310. The secondary memory 310 may include the hard disk drive 312 and a removable storage drive 314, such as an optical disk drive, a flash memory, etc.

The removable storage drive 314 may read from and/or write to the removable storage unit 318 in a well-known manner. The removable storage unit 318 may include a removable storage media that may be read by and written to by the removable storage drive 314. For example, if the removable storage drive 314 is a universal serial port, the removable storage unit 318 may be a portable flash drive, respectively. In one embodiment, the removable storage unit 318 may be non-transitory computer readable recording media.

In some embodiments, the secondary memory 310 may include alternative means for allowing computer programs or other instructions to be loaded into the processing unit 140, for example, the removable storage unit 318 and an interface 320. Examples of such means may include a program cartridge and cartridge interface (e.g., as found in video game systems), a removable memory chip (e.g., EEPROM, PROM, etc.) and associated socket, and other removable storage units 318 and interfaces 320 as will be apparent to persons having skill in the relevant art.

Data stored in the processing unit 140 (e.g., in the main memory 308 and/or the secondary memory 310) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The processing unit 140 may also include a communications interface 324. The communications interface 324 may be configured to allow software and data to be transferred between the processing unit 140 and external devices. Exemplary communications interfaces 324 may include a modem, a network interface (e.g., an Ethernet card), a communications port, a PCMCIA slot and card, etc. Software and data transferred via the communications interface 324 may be in the form of signals, which may be electronic, electromagnetic, optical, or other signals as will be apparent to persons having skill in the relevant art. The signals may travel via a communications path 326, which may be configured to carry the signals and may be implemented using wire, cable, fiber optics, a phone line, a cellular phone link, a radio frequency link, etc.

Computer program medium and computer usable medium may refer to memories, such as the main memory 308 and secondary memory 310, which may be memory semiconductors (e.g., DRAMs, etc.). These computer program products may be means for providing software to the processing unit 140. Computer programs (e.g., computer control logic) may be stored in the main memory 308 and/or the secondary memory 310. Computer programs may also be received via the communications interface 324. Such computer programs, when executed, may enable processing unit 140 to implement the present methods as discussed herein. In particular, the computer programs, when executed, may enable processor device 304 to implement the operative functions of the image sensor as discussed herein. Accordingly, such computer programs may represent controllers of the processing unit 140. Where the present disclosure is implemented, at least in part, using software, the software may be stored in a non-transitory computer readable medium and loaded into the processing unit 140 using the removable storage drive 314, interface 320, and hard disk drive 312, or communications interface 324. Lastly, the processing unit 140 may also include a display interface 302 that outputs display signals to a display unit 330, e.g., LCD screen, plasma screen, LED screen, DLP screen, CRT screen, etc. The display unit 330 can be a separate component connected to the probe 110 of the image sensor 100.

Returning to FIG. 1, for each scan location that the probe 110 is moved over and from which the two-dimensional array receiver 130 receives reflected ultrasound, the processing unit 140 is configured to generate a two-dimensional image for that scan location. The processing unit 140 is configured to convert each reflected ultrasound wave that the two-dimensional array receiver 130 receives into a two-dimensional array of pixels for generating an image of the scan location over which the probe 110 is currently positioned. Thus, with reference to FIG. 1, the processing unit 140 is configured to generate, for a first one of multiple scan locations (e.g., scan location 1 in FIG. 1), a two-dimensional image of the first scan location based on an intensity of the reflected ultrasound from the first scan location.

In addition, the processing unit 140 is configured to generate an aggregate two-dimensional image for the first scan location (e.g., scan location 1 in FIG. 1) which integrates plural two-dimensional images generated using reflected ultrasound of at least two scan locations (e.g., scan locations 1 and 2 in FIG. 1). In accordance with an exemplary embodiment, the processing unit 140 is configured to generate the aggregate two-dimensional image by combining a plurality of two-dimensional images which have been generated for a plurality of scan locations, based on their respective positions in the scan area. For example, the processing unit 140 can, in generating the aggregate two-dimensional image, merge, join and/or overlap a plurality of of two-dimensional images which have been generated for a plurality of scan locations, based on their respective positions in the scan area.

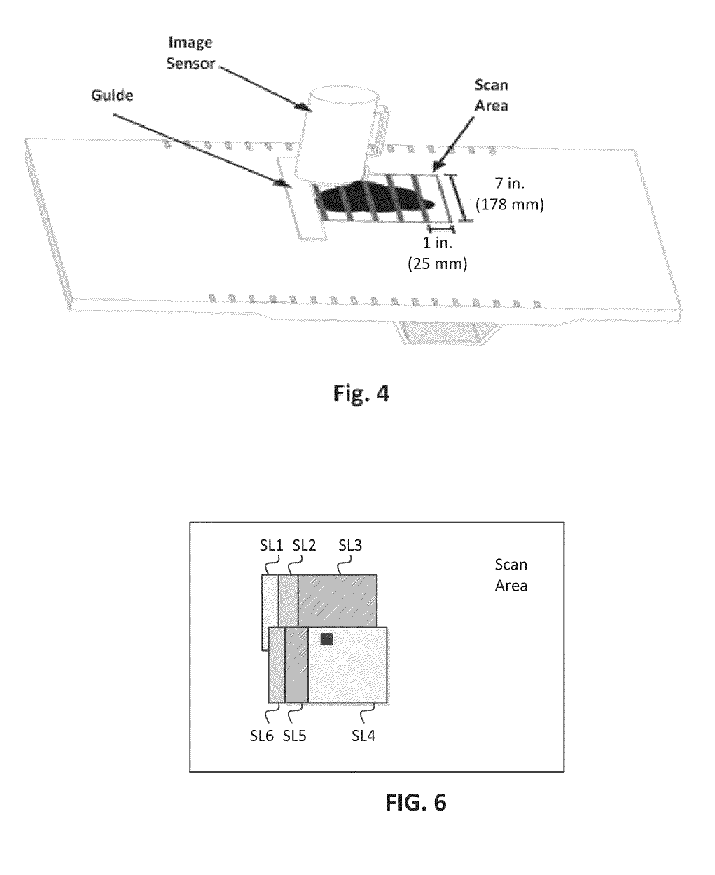

FIG. 4 is an explanatory diagram illustrating an operation of scanning multiple scan locations with the ultrasonic sensor of the present disclosure. In the illustrated example of FIG. 4, the image sensor of the present disclosure is utilized to scan a plurality of scan locations within vertical columns each seven (7) inches in length and one (1) inch in width. Each column can be considered to be a scan area having a plurality of scan locations therein. Furthermore, the combined columns can be considered to be a larger scan area having even more scan locations therein. As illustrated, a guide such as a straight edge can be used to guide the positioning of the image sensor over the various scan locations.

In operation, the processing unit 140 of the image sensor is configured to generate a two-dimensional image of each scan location over which the probe 110 is moved, based on an intensity of the reflected ultrasound from that respective scan location. As the probe 110 is moved to additional scan locations, the processing unit 140 is configured to generate an aggregate two-dimensional image which integrates the respective two-dimensional images generated for two or more of the scan locations. In the example of FIG. 4, the processing unit 140 can generate an aggregate two-dimensional image for each scan location in the leftmost column. Then, the processing unit 140 can generate another aggregate two-dimensional image for each scan location in the next column to the right. Alternatively or in addition, the processing unit 140 can integrate each of these aggregate two-dimensional images to generate a larger scale aggregate two-dimensional image of two or more columns. The processing unit 140 can then cause the generated aggregate two-dimensional image to be displayed on the display unit 330 shown in FIG. 3.

In practice, the probe 110 is configured to be moved relative to at least one of the scan locations a plurality of times before the probe is moved to another scan location. For instance, the processing unit 140, in concert with the ultrasonic source 120 and two-dimensional array receiver 130, is configured to generate two-dimensional images for each scan location at a rate of 30 frames per second, for example. Thus, in operation, the processing unit 140 is configured to generate a new two-dimensional image for at least one of the scan locations each time the probe is moved relative to that scan location so as to generate a plurality of two-dimensional images for that scan location. For example, with reference to FIG. 1, suppose that the processing unit 140 generates a plurality of two-dimensional images for scan location 2. The processing unit 140 is configured to determine whether one of the plurality of two-dimensional images generated for scan location 2 is of a higher quality than the two-dimensional image which has been integrated into the generated aggregate, two-dimensional image for scan location 2. For example, the processing unit 140 can be configured to assign a numerical value to each two-dimensional image generated for scan location 2 based on a variety of factors such as the clarity of the pixels in the respective two-dimensional images, the depth of objects in one two-dimensional image compared to the depth of objections in another two-dimensional image, etc. In accordance with an exemplary embodiment, the processing unit 140 is configured to allocate a score to each pixel in each respective two-dimensional image generated for a corresponding scan location. For example, the processing unit 140 can allocate a score to each pixel based on criteria such as the level of amplitude of the pixel, and the proximity of the pixel to the center of its corresponding two-dimensional image. The processing unit 140 may, for example, allocate a greater score to pixels that have a higher amplitude and are closer to the center of its corresponding two-dimensional image. The processing unit 140 can then be configured to replace the two-dimensional image, or portions thereof (e.g., pixels in the two-dimensional image), that has been integrated into the generated aggregate, two-dimensional image with one of the plurality of two-dimensional images that has been determined to be of a higher quality.

FIG. 5 is a block diagram illustrating the operative components of the processing unit 140 in more detail, according to an exemplary embodiment of the present disclosure. In the embodiment of FIG. 5, the processing unit 140 includes a receiver array processor 142 which processes signals received by the two-dimensional receiver array 130, a transmitter driver 144 which controls the ultrasonic source 120, a signal processor, two-dimensional scan generator 146 which generates the two-dimensional image for each scan location as well as the aggregate, two-dimensional image as described herein, and a user interface and display interface corresponding to the display interface 302 illustrated in FIG. 3. In the example of FIG. 5, the focusing mechanism 150 includes a lens 152 and a beamsplitter 154 which collimates ultrasound that is transmitted to a scan location and/or reflected from the scan location. In addition, in the example of FIG. 5, the positioning unit 160 is implemented as a wheeled encoder. The processing unit 140 is configured to record a position of each pixel it generates with respect to the current position of the image sensor 100.

As noted above, the processing unit 140 includes a memory unit (e.g., main memory 308, secondary memory 310). The memory unit is configured to store therein each of the two-dimensional images generated for a corresponding one of the scan locations and the generated aggregate, two-dimensional image. Thus, the processing unit 140 can replace any of the two-dimensional images with a stored image to integrate into the aggregate, two-dimensional image.

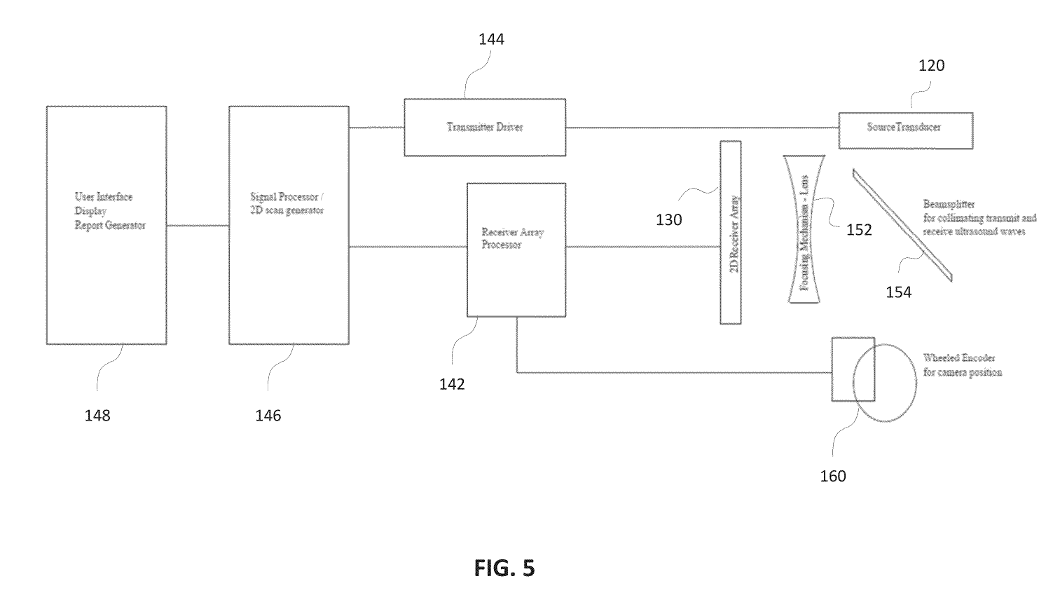

In accordance with an exemplary embodiment, the processing unit 140 is configured to implement a pixel placement algorithm in determining which two-dimensional image, or portion of a two-dimensional image, of a specific scan location to include in the aggregate, two-dimensional image of a scan area. FIG. 6 illustrates a plurality of Cscan frames (i.e., two-dimensional images) which are generated for one or more scan locations as the probe 110 is moved relative to the one or more scan locations.

In the example of FIG. 6, six different, partially overlapping two-dimensional images (represented by different shading) SL1-SL6 are generated by the processing unit 140 within a scan area. Each two-dimensional image SL1-SL6 respectively represents an ultrasound Cscan frame. Each two-dimensional image has an X axis and Y axis orientation which is determined by various positioning techniques described below. The black dot represents a single pixel on the aggregate, two-dimensional image. In the example of FIG. 6, there are six two-dimensional images which paint the black dot and from which the pixel to represent that point on the target will be selected. Note that there is a different location in each two-dimensional image that has the correct location for the pixel to represent the target point in the aggregate, two-dimensional image.

In accordance with an exemplary embodiment, the processing unit 140 can be configured to select which pixels from which two-dimensional image for a given scan location to integrate into the aggregate, two-dimensional image, based on a score attributed to pixels in the corresponding images. For example, with reference to FIG. 6, the processing unit 140 can determine which pixels of the six two-dimensional images SL1-SL6 to include in the aggregate two-dimensional image based on the following algorithm for evaluating the pixel represented as the black dot.

The processing unit 140 first finds the center column and row of the active area in the Cscan frame (e.g., SL1). As used herein, the term “active area” means the area in the Cscan frame in which the ultrasound is detected. The processing unit 140 then assigns an initial score of zero for all pixels in the aggregate scan area. While the scan is active, a corresponding two-dimensional image is respectively generated for each of the scan locations SL1-SL6, and the position of each pixel in the scan locations SL1-SL6 is recorded for each individual two-dimensional image. For each pixel in each of the corresponding two-dimensional images SL1-SL6, the processing unit 140 then assigns a score based on that pixel's distance to the center row and column of the active area in the corresponding two-dimensional image SL1-SL6. For example, the pixel represented by the black dot in FIG. 5 is given a score with respect to its distance from the center row and center column of the active area for image SL1, a score with respect to its distance from the center row and center column of the active area for image SL2, and so on. As noted above, the score assigned to each pixel can be based on criteria such as its amplitude, in addition to its distance from the center of the active area of the corresponding image SL1-SL6.

The processing unit 140 then computes the position of the pixel in the scan area for which the aggregate two-dimensional image is to be generated, by using the position of the corresponding two-dimensional image SL1-SL6 as well as the position of the pixel in that image. Then, the processing unit 140 compares the pixel score in one of the images SL1-SL6 to the pixel score in another one of the images. If the pixel score is higher in one of the images (e.g., image SL2) than it is in another one of the images (e.g., image SL4), the processing unit 140 utilizes the pixel in image SL2 for generating the pixel in the corresponding location of the aggregate, two-dimensional image. In case the processing unit has already generated the aggregate, two dimensional image utilizing, for example, image SL2 and subsequently determines that the pixel in image SL4 has a higher score value than in image SL2, the processing unit 140 can replace the pixel in the aggregate, two-dimensional image with the corresponding pixel in image SL4.

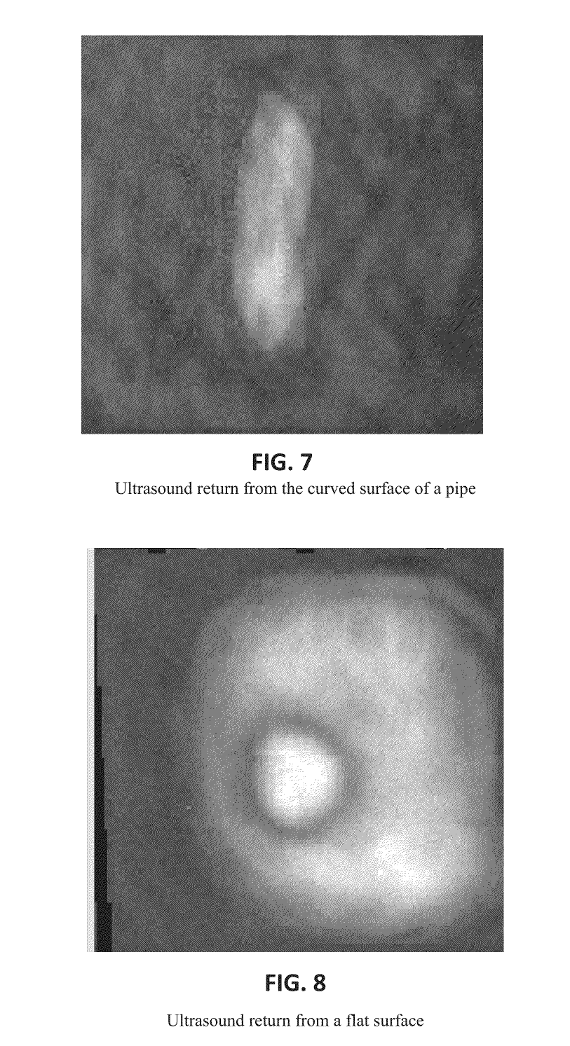

FIGS. 7 and 8 illustrate examples of the pixel placement algorithm utilized by the processing unit 140 for determining which two-dimensional images to integrate into the aggregate, two-dimensional image for a particular scan location. FIGS. 7 and 8 differ with respect primarily to the scan area. In accordance with an exemplary embodiment of the present disclosure, the image sensor can be utilized for scan areas which are a flat surface and/or a curved surface. FIG. 7 illustrates an example of a scan area which is a curved surface, while FIG. 8 illustrates an example of a scan area which is a flat surface.

To illustrate the pixel placement algorithm in more detail, FIG. 7 represents an example of a pipe with curved surface, and FIG. 8 represents a calibration standard with a flat surface. Each example illustrates different aspects of the algorithm. An image of an ultrasound return from a curved pipe is shown in FIG. 7. Note that the active area of the ultrasound return is found only in a narrow cylinder in the center of the image. This is because the curvature of the pipe reflects the ultrasound away from the two-dimensional array receiver 140 in all but a narrow area where the surface of the pipe is perpendicular to the two-dimensional array receiver 140. This places a restriction on which pixels can be used for the aggregate, two-dimensional image. An average of the ultrasound return from the entire image is taken and a 50% over average threshold is established. Pixels which exceed the threshold are considered part of the active area and may be selected for pixel placement in the aggregate, two-dimensional image. Within the active area, the vertical centerline is calculated and the closer a pixel is to the centerline the higher its score and the more desirable for selection in the aggregate, two-dimensional image.

A flat surface provides more flexibility in the calculation of the most desirable pixel for inclusion in the area scan. FIG. 8 shows a return from a target with a flat surface. The active area is much larger because there is no curvature to reflect away the ultrasound. Note that the active area is not centered in the image in FIG. 8. The active area is calculated during a calibration procedure as in the previous example of FIG. 7, except in this example the horizontal centerline is calculated as well as the vertical centerline. The pixel score is now based on the square root of the sum of the squares of the pixel position to the horizontal and vertical center point of the active area.

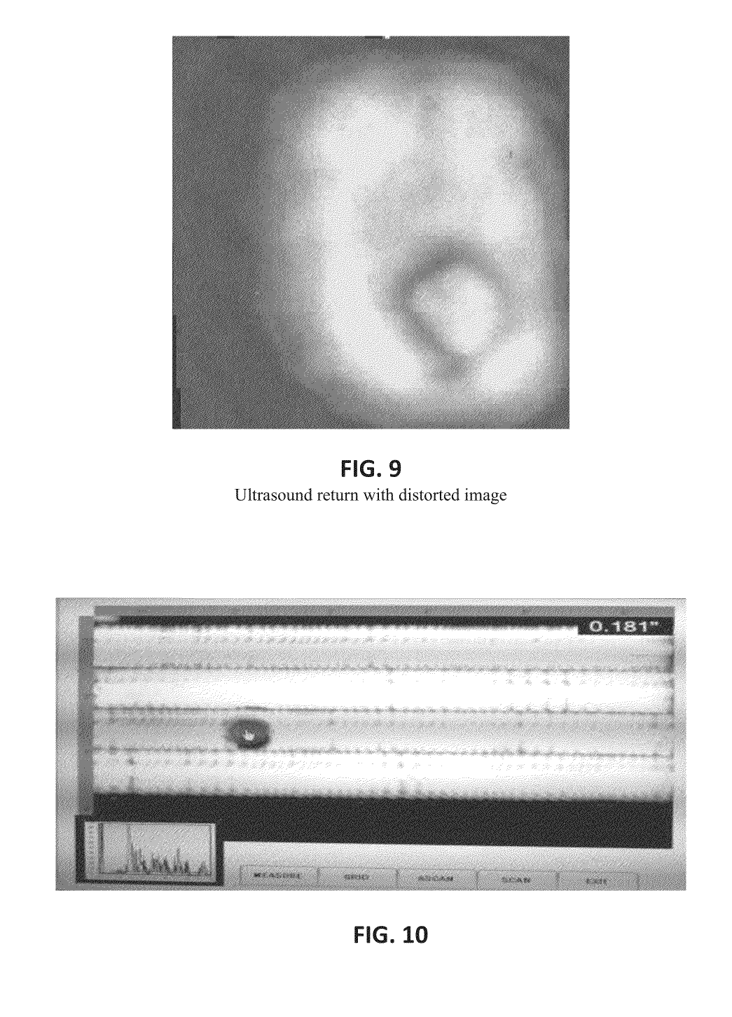

According to an exemplary embodiment, the flat surface pixel selection algorithm can be refined by eliminating areas of distorted imaging. With reference to FIG. 9, there may be areas of the image which do not focus perfectly due, for example, to issues with lenses. The sub-surface hole shown in FIG. 9 is distorted, the hole is not round and the edge is fuzzy as compared to the more perfectly formed hole in FIG. 8. The areas of distorted imaging can be determined through a calibration operation. For example, in the calibration operation, a test pattern could be imaged and the areas of distortion could be removed from the active area based on the test pattern. In accordance with an exemplary embodiment, the calibration operation utilizes the target and features in the target to determine areas of distortion.

FIG. 10 illustrates an example of an aggregate, two-dimensional image which can be generated by the image sensor of the present disclosure. FIG. 10 represents an example where the scan area includes a plurality of scan locations in a first row of the scan area, and a plurality of scan locations in a second row of the scan area adjacent to the first row. In the example of FIG. 10, the processing unit 140 is configured to generate the aggregate, two dimensional image by integrating the images of the scan locations in a first row of the aggregate, two dimensional image, and integrating the images of the scan locations in a second row of the aggregate, two dimensional image.

In the example of FIG. 10, the dark horizontal lines indicating a separation between different rows of scanning with the image sensor are provided to illustrate how the aggregate, two dimensional image can be generated to integrate any number of different scan locations in various rows. The illustrated rows can be removed by integrating the pixels of scan locations bordering the illustrated rows. FIG. 10 illustrates an example of an aggregate, two dimensional image generated based on scanning different rows of a scan area. The same operation can be performed if different columns are scanned, or if a freestyle scanning operation with the probe 110 is implemented.

As shown in FIG. 10, a user can select a particular portion of the aggregate, two dimensional image to determine further details of a particular scan location within the scan area. FIG. 10 is an example of an aggregate, two dimensional image of a steel plate with a spot of corrosion. As illustrated in the lower left hand corner of FIG. 10, a more detailed image of the spot of corrosion in the scan area can be selected to reveal additional details such as thickness readings for that scan location. Numerous other types of desired data can be provided for a particular scan location within an aggregate, two dimensional image.

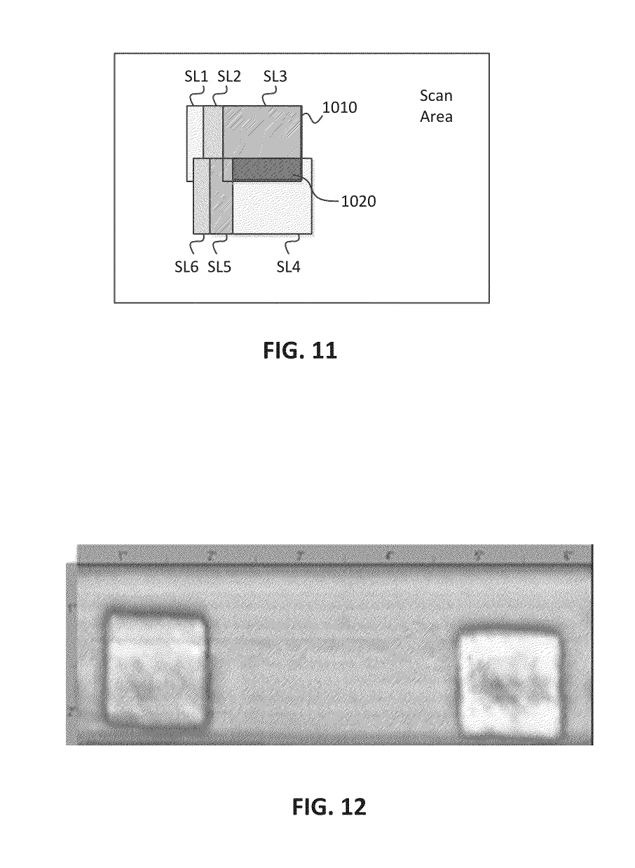

The example of FIG. 10 was generated using a guide to position the probe 110 in various X and Y positions over the scan area. During the scanning of different rows (or columns, or in a freestyle scanning operation), the aggregate, two dimensional image may include at least one overlap region including a portion of the two dimensional image generated for a first scan location, and a portion of a two-dimensional image generated for a second scan location. FIG. 11 illustrates an example of an overlap region between the two-dimensional images generated for different scanning operations. The thick, solid rectangle 1010 in FIG. 11 represents a scan location for which there is an overlap region 1020 that includes a portion of a two-dimensional image SL3 generated by the processing unit 140 for a first scan location and another two-dimensional image SL4 generated by the processing unit 140 for a second scan location. Based on the overlap region 1020, the processing unit 140 can regenerate either or both of the two-dimensional images SL3, SL4 using the overlap region 1020 in the aggregate, two dimensional image.

Thus, in the example of FIG. 11, the aggregate, two dimensional image includes at least one overlap region including a portion of the two-dimensional images generated for a first row of the aggregate, two dimensional image, and a portion of the two-dimensional images generated for the second row of the aggregate, two dimensional image. The processing unit 140 can regenerate at least one of the respective two-dimensional images for any of the scan locations using the overlap region in the aggregate, two dimensional image.

Further, in the example of FIG. 11, the processing unit 140, in generating the aggregate, two dimensional image, is configured to merge portions of the two-dimensional images for any of the scan locations appearing at an intersection of the rows in the scan area to merge the corresponding portions in the aggregate, two dimensional image. A similar operation can be performed by the processing unit 140 if the probe 110 is moved in various columns or by freehand motion. For example, in the case of freehand motion of the probe 110, the processing unit 140 is configured to generate the aggregate, two dimensional image corresponding to the freehand motion in which the probe 110 is moved.

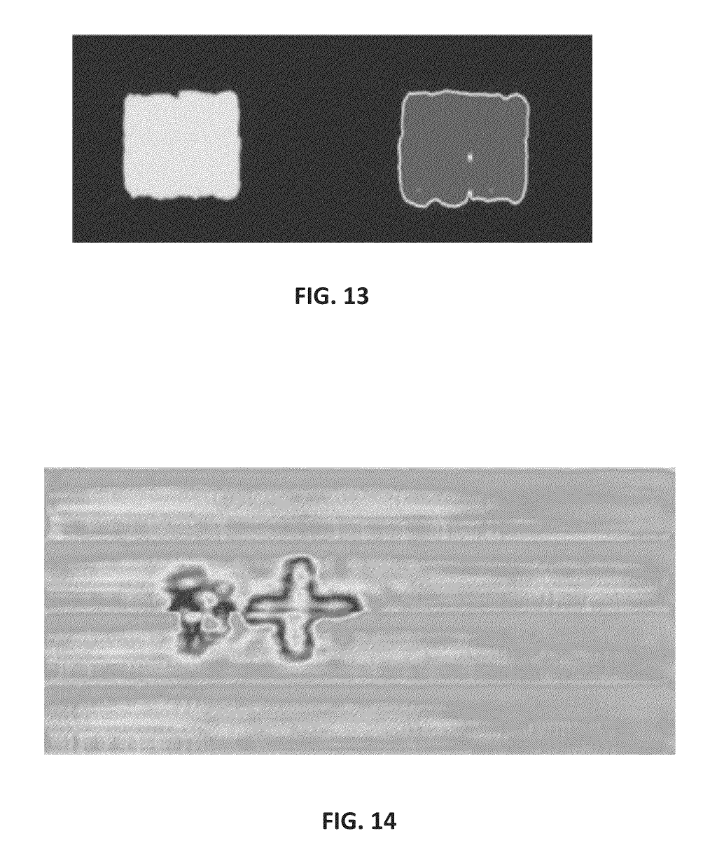

The processing unit 140 can provide various graphical effects to different features illustrated in an aggregate, two dimensional image for a scan area. For example, with reference to FIG. 12, the processing unit 140 can provide different grey scale imaging based on different thicknesses or depth levels. With reference to FIG. 13, the processing unit 140 can provide different colors or shading for different depth levels. Thus, the processing unit 140 can provide so-called time of flight imagery for the aggregate, two-dimensional image. As shown in FIG. 14, the processing unit 140 can provide false colors for different objects based on their thickness and/or depth readings.

Accordingly, the processing unit 140, in generating the aggregate two-dimensional image, is configured to assign at least one of different intensities and different colors to different ranges of depth of objects contained in the scan area. The processing unit 140 is configured to generate the aggregate two-dimensional image to contain at least one of different intensities and different colors to represent the different ranges of depth of objects contained in the scan area.

The processing unit 140 is also configured to determine a thickness from the probe 110 to at least one object contained in a corresponding one of at least two scan locations as the probe 110 is moved relative to the scan locations. The probe 110 is configured to be moved in a direction substantially parallel (e.g., longitudinal) to a surface of an object to be scanned. In addition, the probe 110 is configured to be held at a shear wave angle (e.g., a predetermined angle) relative to a surface of an object to be scanned, and to focus the ultrasound on at least one scan location at the shear wave angle, as disclosed in U.S. Pat. No. 7,370,534, the entire disclosure of which is hereby incorporated by reference in its entirety.

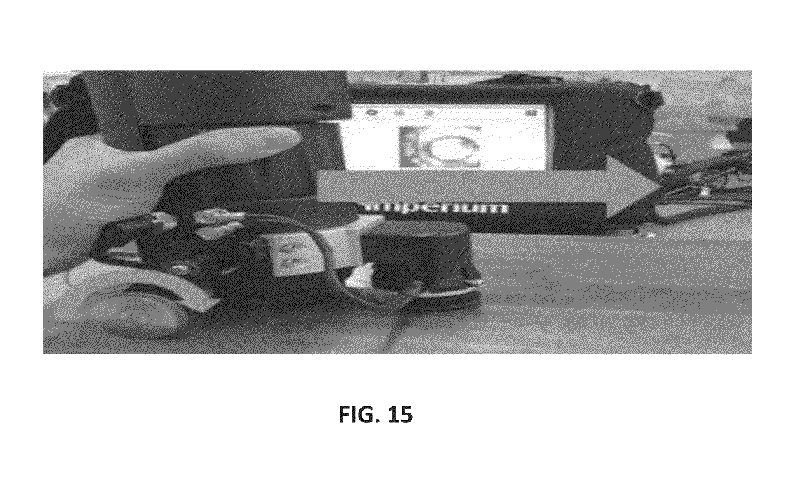

As described above, a positioning system is utilized in the present disclosure to determine the placement of the probe relative to different scan locations in a scan area, for use in generating the two-dimensional images for each scan location and the integration of the two-dimensional images in the aggregate, two-dimensional image. FIG. 15 illustrates an example of a freestyle scanning system onto which the probe 110 can be mounted.

For example, the image sensor 100 can include a wheeled position encoder attached to the probe 110, where the wheeled position encoder has at least one wheel configured to rotate across the scan area as the probe 110 is moved relative to the scan area. The processing unit 140 is configured to derive a position of the probe on the scan area based on an amount of rotation of the at least one wheel of the wheeled position encoder, and to generate the aggregate, two dimensional image based on the derived position of the probe on the scan area.

As another example, the image sensor 100 can include a string position encoder attached to the probe 110, where the string position encoder has at least two strings attached to the probe 110 in perpendicular directions to one another, and at least two string encoders arranged in quadrature. The at least two string encoders are configured to generate Cartesian position information of the probe on the scan area based on a movement of the probe 110 relative to the scan area. The processing unit 140 is configured to derive a position of the probe 110 on the scan area based on the Cartesian position information generated by the at least two string encoders, and to generate the aggregate, two dimensional image based on the derived position of the probe on the scan area.

As another example, the image sensor 100 can include a wireless position encoder attached to the probe 110, where the wireless position encoder includes at least two reflectors attached to the probe 110 on perpendicular sides of the probe 110, and at least two wireless sources arranged in quadrature and configured to output wireless signals toward the probe 110 and respectively receive reflected wireless signals from the at least two reflectors. The wireless position encoder is configured to generate Cartesian position information of the probe on the scan area based on a movement of the probe relative to the scan area. In addition, the processing unit 140 is configured to derive a position of the probe 110 on the scan area based on the Cartesian position information generated by the wireless position encoder, and to generate the aggregate, two dimensional image based on the derived position of the probe on the scan area.

In accordance with an exemplary embodiment, the processing unit 140 is configured to generate the aggregate, two dimensional image after the probe 110 is moved relative to a predetermined number of the scan locations in the scan area. The predetermined number of scan locations can be defined differently based on operator control.

In accordance with an exemplary embodiment, the processing unit 140 is configured to generate the aggregate, two dimensional image after the probe 110 is moved over all scan locations in the scan area.

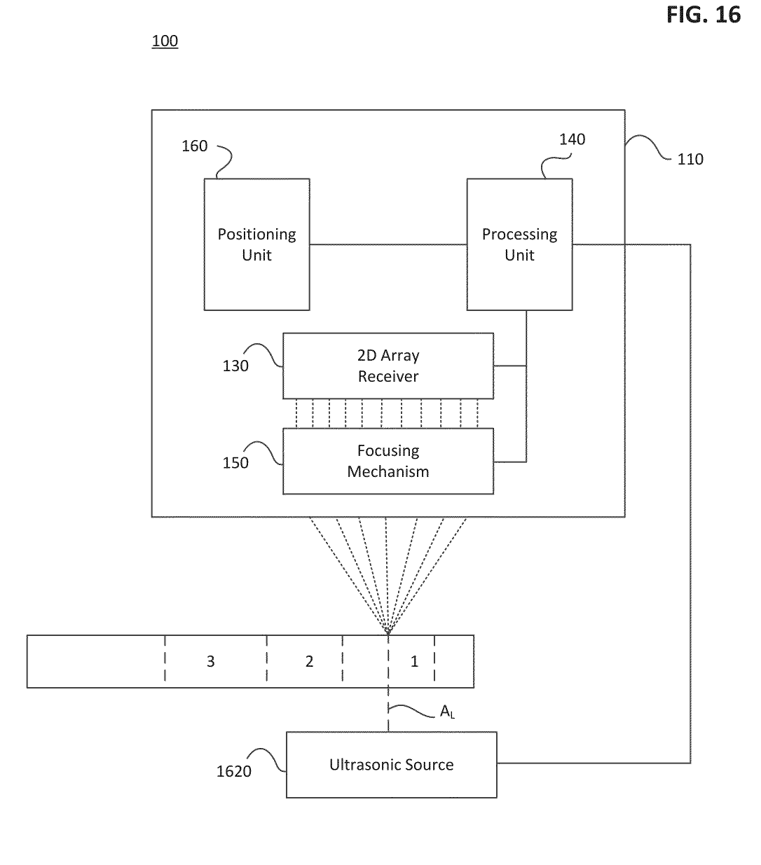

In the exemplary embodiment of FIG. 1, the ultrasonic source is illustrated as being comprised in the probe 110. The features of the present disclosure are also applicable to other ultrasonic scanning techniques such as the configuration illustrated in FIG. 16, which illustrates a block diagram of an ultrasonic image sensor according to an exemplary embodiment of the present disclosure. In the exemplary embodiment of FIG. 16, the ultrasonic source 1620 is separated from the probe 110 in which the two-dimensional array receiver 130, processing unit 140, focusing mechanism 150 and positioning unit 160 are housed. The two-dimensional array receiver 130 receives ultrasound which is transmitted through each scan location over which the probe 110 is moved, as opposed to receiving ultrasound which is reflected from the scan locations as in FIG. 1. In the example of FIG. 16, the two-dimensional array receiver 130 receives ultrasound which is transmitted through scan location 1 from the ultrasonic source 1620 located below the object to be scanned. Similar to the above-described exemplary embodiments, for each scan location that the probe 110 is moved over and from which the two-dimensional array receiver 130 receives transmitted ultrasound, the processing unit 140 is configured to generate a two-dimensional image for that scan location. The processing unit 140 is configured to convert each reflected ultrasound wave that the two-dimensional array receiver 130 receives into a two-dimensional array of pixels for generating an image of the scan location over which the probe 110 is currently positioned. Thus, with reference to FIG. 16, the processing unit 140 is configured to generate, for a first one of multiple scan locations (e.g., scan location 1 in FIG. 16), a two-dimensional image of the first scan location based on an intensity of the ultrasound transmitted through the first scan location. Furthermore, in accordance with the exemplary embodiments described above, the processing unit 140 is configured to generate an aggregate two-dimensional image for the first scan location (e.g., scan location 1 in FIG. 16) which integrates plural two-dimensional images generated using reflected ultrasound of at least two scan locations (e.g., scan locations 1 and 2 in FIG. 16).

In the exemplary embodiment of FIG. 16, the processing unit 140 is in electrical communication via wired or wireless media to communicate with the ultrasonic source 1620 for synchronization and positioning. According to an exemplary embodiment, the ultrasonic source 1620 and the probe 110 are connected to each other on a rail system such that the probe 110 moves in unison with the ultrasonic source 1620. Any of the other positioning techniques described above can also be used.

It is to be understood that notwithstanding the different positions of the ultrasonic source in the embodiments of FIGS. 1 and 16, the image sensor as illustrated in FIG. 16 is configured to perform all the operative features of the embodiments described hereinabove.

In addition to the exemplary image sensors as described above, the present disclosure also provide a method of operating an ultrasonic image sensor, in accordance with the exemplary embodiments described above. For example, the method of the present disclosure includes outputting ultrasound from a probe onto a scan area, moving the probe relative to at least two adjacent scan locations of the scan area such that the ultrasound will be focused on each of the at least two scan locations as the probe is moved relative to the scan area to provide an array of scanned images, determining the position of the probe relative to the scan locations in the scan area over which the probe is moved, generating position information indicating the position of the probe relative to each scan location, and receiving ultrasound reflected from each of the at least two scan locations. In addition, the exemplary method includes generating, for a first of the two scan locations, a two-dimensional image of the first scan location based on an intensity of the reflected ultrasound from the first scan location, and generating an aggregate two-dimensional image for the first scan location which integrates plural two-dimensional images generated using reflected ultrasound of the at least two scan locations based on the generated position information.

The present disclosure also provides a non-transitory computer-readable medium (e.g., removable storage unit 318, and a hard disk installed in hard disk drive 312 in FIG. 3) that has tangibly recorded thereon a computer program that, when executed, causes a processor of an ultrasonic image sensor to perform the operative functions of the image sensor as described herein. Therefore, existing image sensors can be modified to be able to perform the operative features described herein by tangibly recording a computer program embodying the features of the present disclosure on a non-transitory computer-readable recording medium. In accordance with an exemplary embodiment, the computer program causes a processor of an ultrasonic image sensor to perform operations including: (i) outputting ultrasound from a probe onto each scan location of a scan area over which the image sensor is moved, such that the ultrasound will be focused on each of the at least two scan locations as the image sensor is moved relative to the scan area to provide an array of scanned images; (ii) determining the position of the probe relative to the scan locations in the scan area over which the probe is moved, and generating position information indicating the position of the probe relative to each scan location; (iii) receiving ultrasound reflected from each of the at least two scan locations; (iv) generating, for a first of the two scan locations, a two-dimensional image of the first scan location based on an intensity of the reflected ultrasound from the first scan location; and (v) generating an aggregate two-dimensional image for the first scan location which integrates plural two-dimensional images generated using reflected ultrasound of the at least two scan locations based on the generated position information.

While the present disclosure has been illustrated and described in detail in the drawings and foregoing description, such illustration and description are to be considered illustrative or exemplary and not restrictive. The present disclosure is not limited to the exemplary embodiments described above. Other variations to the disclosed exemplary embodiments can be understood and effected by those skilled in the art in practicing the claimed disclosure, from a study of the drawings, the disclosure, and the appended claims. In the claims, the word “comprising” or “including” does not exclude other elements or steps, and the independent article “a” or “an” does not exclude a plurality. The mere fact that certain measures are recited in mutually different dependent claims does not indicate that a combination of these measures cannot be used to advantage.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. An ultrasonic image sensor, comprising:
an ultrasonic source configured to output ultrasound;
a probe for emitting the ultrasound onto a scan area, the probe being moveable relative to at least two adjacent scan locations of the scan area such that the ultrasound will be focused on each of the at least two scan locations as the probe is moved relative to the scan area to provide an array of scanned images;
an ultrasonic, two-dimensional array receiver configured to receive ultrasound reflected from each of the at least two scan locations; and
a processing unit configured to generate, for a first of the two scan locations, a two-dimensional image of the first scan location based on an intensity of the reflected ultrasound from the first scan location, and to generate an aggregate two-dimensional image for the first scan location which integrates plural two-dimensional images generated using reflected ultrasound of the at least two scan locations based on a position of the probe relative to the at least scan locations, respectively.

2. The ultrasonic image sensor according to claim 1, comprising:
a positioning unit configured to determine the position of the probe relative to the scan locations in the scan area over which the probe is moved, and to generate position information indicating the position of the probe relative to each scan location,
wherein the processing unit is configured to generate the aggregate two-dimensional image for the first scan location which integrates plural two-dimensional images generated using reflected ultrasound of the at least two scan locations based on the position information generated by the positioning unit.

3. The ultrasonic image sensor according to claim 1, comprising:
a transceiver which includes the ultrasonic source and the ultrasonic, two-dimensional array receiver.

4. The ultrasonic image sensor according to claim 1, wherein the ultrasonic source is a two-dimensional array source configured to output the ultrasound two-dimensionally.

5. The ultrasonic image sensor according to claim 1, comprising:
a focusing mechanism configured to focus the ultrasound output from the ultrasonic source onto one of the scan locations on which the probe is moved.

6. The ultrasonic image sensor according to claim 5, wherein the focusing mechanism comprises a first lens configured to focus the ultrasound output from the ultrasonic source onto one of the scan locations on which the probe is moved.

7. The ultrasonic image sensor according to claim 5, wherein the focusing mechanism is configured to focus the ultrasound respectively reflected from each of the scan locations relative to which the probe is moved onto the two-dimensional array receiver.

8. The ultrasonic image sensor according to claim 7, wherein the focusing mechanism comprises a second lens configured to focus the ultrasound respectively reflected from each of the scan locations relative to which the probe is moved onto the two-dimensional array receiver.

9. The ultrasonic image sensor according to claim 5, comprising:
a transceiver which includes the ultrasonic source and the ultrasonic, two-dimensional array receiver,
wherein the focusing mechanism comprises an electron beam former configured to focus the ultrasound output from the transceiver onto one of the scan locations on which the probe is moved, and to focus the ultrasound respectively reflected from each of the scan locations relative to which the probe is moved onto the transceiver.

10. The ultrasonic image sensor according to claim 1, wherein the processing unit is configured to generate the aggregate, two dimensional image in real time as the probe is moved relative to the second scan location.

11. The ultrasonic image sensor according to claim 1, wherein the aggregate, two dimensional image includes a real-time array of respective two-dimensional images of each scan location relative to which the probe is moved.

12. The ultrasonic image sensor according to claim 1, comprising:
a display unit configured to display the aggregate, two dimensional image generated by the processing unit.

13. The ultrasonic image sensor according to claim 1, wherein the probe is configured to be moved relative to at least one of the scan locations a plurality of times,
wherein the processing unit is configured to generate a new two-dimensional image for the at least one of the scan locations each time the probe is moved relative to the at least one of the scan locations so as to generate a plurality of two-dimensional images for that scan location,
wherein the processing unit is configured to determine whether one of the plurality of two-dimensional images generated for the at least one of the scan locations is of a higher quality than the two-dimensional image which has been integrated into the generated aggregate, two-dimensional image for that scan location, and
wherein the processing unit is configured to replace the two-dimensional image that has been integrated into the generated aggregate, two-dimensional image with one of the plurality of two-dimensional images that has been determined to be of a higher quality.

14. The ultrasonic image sensor according to claim 13, wherein the processing unit comprises a memory unit configured to store therein each of the two-dimensional images generated for a corresponding one of the scan locations and the generated aggregate, two-dimensional image.

15. The ultrasonic image sensor according to claim 1, wherein the processing unit is configured to generate the aggregate, two dimensional image after the probe is moved relative to a predetermined number of the scan locations in the scan area.

16. The ultrasonic image sensor according to claim 1, wherein the processing unit is configured to generate the aggregate, two dimensional image after the probe is moved over all scan locations in the scan area.

17. The ultrasonic image sensor according to claim 1, wherein the aggregate, two dimensional image includes at least one overlap region including a portion of the image generated for the first scan location, and a portion of a two-dimensional image generated for the second scan location, and
wherein the processing unit is configured to regenerate at least one of the image for the first scan location and the image for the second scan location using the overlap region in the aggregate, two dimensional image.

18. The ultrasonic image sensor according to claim 1, wherein the scan area includes the first and second scan locations in a first row of the scan area, and third and fourth scan locations in a second row of the scan area adjacent to the first row, and
wherein the processing unit is configured to generate the aggregate, two dimensional image to integrate the images of the first and second scan locations in a first row of the aggregate, two dimensional image, and to integrate the images of the third and fourth scan locations in a second row of the aggregate, two dimensional image.

19. The ultrasonic image sensor according to claim 18, wherein the aggregate, two dimensional image includes at least one overlap region including a portion of the images generated for the first row of the aggregate, two dimensional image, and a portion of the images generated for the second row of the aggregate, two dimensional image,
wherein the processing unit is configured to regenerate at least one of the respective two-dimensional images for the first to fourth scan locations using the overlap region in the aggregate, two dimensional image.

20. The ultrasonic image sensor according to claim 18, wherein the processing unit, in generating the aggregate, two dimensional image, is configured to merge portions of the two-dimensional images for any of the scan locations appearing at an intersection of the rows in the scan area to merge the corresponding portions in the aggregate, two dimensional image.

21. The ultrasonic image sensor according to claim 1, wherein the probe is configured to be moved in the scan area in a freehand motion, and
wherein the processing unit is configured to generate the aggregate, two dimensional image corresponding to the freehand motion in which the probe is moved.

22. The ultrasonic image sensor according to claim 21, comprising:
a wheeled position encoder attached to the probe, the wheeled position encoder having at least one wheel configured to rotate across the scan area as the probe is moved relative to the scan area,
wherein the processing unit is configured to derive a position of the probe on the scan area based on an amount of rotation of the at least one wheel of the wheeled position encoder, and to generate the aggregate, two dimensional image based on the derived position of the probe on the scan area.

23. The ultrasonic image sensor according to claim 1, comprising:
a string position encoder attached to the probe, the string position encoder having at least two strings attached to the probe in perpendicular directions to one another, and at least two string encoders arranged in quadrature, the at least two string encoders being configured to generate Cartesian position information of the probe on the scan area based on a movement of the probe relative to the scan area,
wherein the processing unit is configured to derive a position of the probe on the scan area based on the Cartesian position information generated by the at least two string encoders, and to generate the aggregate, two dimensional image based on the derived position of the probe on the scan area.

24. The ultrasonic image sensor according to claim 1, comprising:
a wireless position encoder attached to the probe, the wireless position encoder comprising at least two reflectors attached to the probe on perpendicular sides of the probe, and at least two wireless sources arranged in quadrature and configured to output wireless signals toward the probe and respectively receive reflected wireless signals from the at least two reflectors, the wireless position encoder being configured to generate Cartesian position information of the probe on the scan area based on a movement of the probe relative to the scan area,
wherein the processing unit is configured to derive a position of the probe on the scan area based on the Cartesian position information generated by the wireless position encoder, and to generate the aggregate, two dimensional image based on the derived position of the probe on the scan area.

25. The ultrasonic image sensor according to claim 1, wherein the probe is mounted onto a fixed scanning system.

26. The ultrasonic image sensor according to claim 1, wherein the scan area is a flat surface.

27. The ultrasonic image sensor according to claim 1, wherein the scan area includes a curved surface.

28. The ultrasonic image sensor according to claim 1, wherein the ultrasonic, two-dimensional array receiver comprises:
a plurality of sensors arranged in n rows and n columns, where n is greater than or equal to two.

29. The ultrasonic image sensor according to claim 1, wherein the probe is configured to be moved in a direction longitudinal to a surface of an object to be scanned.

30. The ultrasonic image sensor according to claim 1, wherein the probe is configured to be held at a shear wave angle relative to a surface of an object to be scanned, and to focus the ultrasound on at least one of the scan locations at the shear wave angle.

31. The ultrasonic image sensor according to claim 1, wherein the processing unit, in generating the aggregate two-dimensional image, is configured to assign at least one of different intensities and different colors to different ranges of depth of objects contained in the scan area, and
wherein the processing unit is configured to generate the aggregate two-dimensional image to contain the at least one of different intensities and different colors to represent the different ranges of depth of objects contained in the scan area.

32. The ultrasonic image sensor according to claim 1, wherein the processing unit is configured to determine a thickness from the probe to at least one object contained in a corresponding one of the at least two scan locations as the probe is moved relative to the scan locations.

33. The ultrasonic image sensor according to claim 1, wherein the processing unit comprises a memory unit configured to store therein each of the two-dimensional images generated for a corresponding one of the scan locations and the generated aggregate, two-dimensional image.

34. A method of operating an ultrasonic image sensor, the method comprising:
outputting ultrasound from a probe onto a scan area;
moving the probe relative to at least two adjacent scan locations of the scan area such that the ultrasound will be focused on each of the at least two scan locations as the probe is moved relative to the scan area to provide an array of scanned images;
receiving ultrasound reflected from each of the at least two scan locations;
generating, for a first of the two scan locations, a two-dimensional image of the first scan location based on an intensity of the reflected ultrasound from the first scan location; and
generating an aggregate two-dimensional image for the first scan location which integrates plural two-dimensional images generated using reflected ultrasound of the at least two scan locations based on a position of the probe relative to the at least two scan locations, respectively.

35. The method according to claim 34, comprising:
determining the position of the probe relative to the scan locations in the scan area over which the probe is moved, and generating position information indicating the position of the probe relative to each scan location; and
generating the aggregate two-dimensional image for the first scan location which integrates plural two-dimensional images generated using reflected ultrasound of the at least two scan locations based on the generated position information.

36. A non-transitory computer-readable recording medium having a computer program recorded thereon that, when executed, causes a processor of an ultrasonic image sensor to perform operations comprising:
outputting ultrasound from a probe onto each scan location of a scan area over which the image sensor is moved, such that the ultrasound will be focused on each of the at least two scan locations as the image sensor is moved relative to the scan area to provide an array of scanned images;
receiving ultrasound reflected from each of the at least two scan locations;
generating, for a first of the two scan locations, a two-dimensional image of the first scan location based on an intensity of the reflected ultrasound from the first scan location; and
generating an aggregate two-dimensional image for the first scan location which integrates plural two-dimensional images generated using reflected ultrasound of the at least two scan locations based on a position of the probe relative to the at least two scan locations, respectively.

37. The non-transitory computer readable recording medium according to claim 36, wherein the operations comprise:
determining the position of the probe relative to the scan locations in the scan area over which the probe is moved, and generating position information indicating the position of the probe relative to each scan location; and
generating the aggregate two-dimensional image for the first scan location which integrates plural two-dimensional images generated using reflected ultrasound of the at least two scan locations based on the generated position information.

38. An ultrasonic image sensor, comprising:
an ultrasonic source configured to output ultrasound;
a probe for emitting the ultrasound onto a scan area, the probe being moveable relative to at least two adjacent scan locations of the scan area such that the ultrasound will be focused on each of the at least two scan locations as the probe is moved relative to the scan area to provide an array of scanned images;
a positioning unit configured to determine the position of the probe relative to the scan locations in the scan area over which the probe is moved, and to generate position information indicating the position of the probe relative to each scan location;
an ultrasonic, two-dimensional array receiver configured to receive ultrasound transmitted through each of the at least two scan locations; and
a processing unit configured to generate, for a first of the two scan locations, a two-dimensional image of the first scan location based on an intensity of the ultrasound transmitted through the first scan location, and to generate an aggregate two-dimensional image for the first scan location which integrates plural two-dimensional images generated using ultrasound transmitted through the at least two scan locations based on the position information generated by the positioning unit.

39. The ultrasonic image sensor according to claim 38, comprising:
a positioning unit configured to determine the position of the probe relative to the scan locations in the scan area over which the probe is moved, and to generate position information indicating the position of the probe relative to each scan location,
wherein the processing unit is configured to generate the aggregate two-dimensional image for the first scan location which integrates plural two-dimensional images generated using ultrasound transmitted through the at least two scan locations based on the position information generated by the positioning unit.
